(19) United States
(12) Patent Application Publication
(10) Pub. No.: US 2010/0251190 A1
(43) Pub. Date: Sep. 30, 2010

(54) SEMICONDUCTOR SUBSTRATE WIRING DESIGN SUPPORT DEVICE AND CONTROL METHOD THEREOF

(75) Inventor: Koichi NAKAGAWA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/748,736

(22) Filed: Mar. 29, 2010

(30) Foreign Application Priority Data
Mar. 31, 2009 (JP) 2009-87911

(51) Int. Cl. G06F 17/50

(52) U.S. Cl. 716/2

(57) ABSTRACT

A semiconductor substrate wiring design support device includes a memory unit that stores logical connection information and a wiring unit that performs wiring based on the logical connection information and provides a single via between a first and a second wire layer when the wiring is a wire between the first and the second wire layer. An isolated-via-error detection unit detects the single via as an isolated-via-error when only the single via is provided in a case where a plurality of vias may be needed according to a via alteration rule. An isolated-via-error-treatment via alteration unit alters a single via detected as the isolated-via-error to an isolated-via-error-treatment via, and a redundancy via alteration unit alters a single via to a redundancy via after the alteration to the isolated-via-error-treatment via.

### CROSS-REFERENCE TO RELATED APPLICATIONS

This application is based upon and claims priority to prior Japanese Patent Application No. 2009-87911 filed on Mar. 31, 2009 in the Japan Patent Office, the entire contents of which are incorporated herein by reference.

### FIELD

An embodiment discussed herein relates to a semiconductor substrate wiring design support device and a method of controlling the semiconductor substrate wiring design support device.

### BACKGROUND

It is desirable that vias, electrically connecting wires in different wiring layers, are provided in shapes such that unnecessary spaces for wiring channels, used as wiring areas, may be reduced as much as it could be, in semiconductor integrated circuits. In addition, it is also desirable that shapes or the like of the vias be defined to avoid excessively complicated processing carried out by the semiconductor substrate wiring design support device. For this reason, wiring by use of a via, having a singular hole (that is, a single-hole-via), is known for wires of signals except wirings in which high-speed signals are used.

However, a phenomenon called “stress migration” has been known. In the “stress migration”, the vias in a semiconductor integrated circuit are damaged due to stress or the like across the ages, so that a durable period of the semiconductor integrated circuit decreases. This “stress migration” is the phenomenon in which bubbles called “vacancy” generated in metal wires migrate by a stress gradient occurred in the wires. Concentration of this “vacancy” on the via by the migration results in growth of a gap called “void.” The growth of this gap causes the damage of the via. To achieve high tolerability relative to this stress migration, a method of known. See [Patent Document 1] Japanese Laid-open Patent Application No. 2007-115959; and [Patent Document 2] Japanese Laid-open Patent Application No. 2007-329361.

### SUMMARY

According to an aspect of an embodiment of the invention, a semiconductor substrate wiring design support device includes a memory unit that stores logical connection information, a wiring unit that performs wiring based on the logical connection information and provides a single via between a first and a second wire layer when the wiring is a wire between the first and the second wire layer, an isolated-via-error detection unit that detects the single via as an isolated-via-error when only the single via is provided in a case where a plurality of vias may be needed according to a via alteration rule, for example, a case where a plurality of vias are needed corresponding to a first wire width based on the first wire width and the second wire width, an isolated-via-error-treatment via alteration unit that alters a single via detected as the isolated-via-error to an isolated-via-error-treatment via, and a redundancy via alteration unit that alters a single via to a redundancy via after the alteration to the isolated-via-error-treatment via.

It is to be understood that both the foregoing general description and the following detailed description are exemplary and explanatory and are not restrictive of the invention, as claimed.

### BRIEF DESCRIPTION OF DRAWINGS

FIG. 1 illustrates a block diagram of a semiconductor substrate wiring design support device;

FIG. 2 illustrates a diagram explaining a control method performed by the semiconductor substrate wiring design support device;

FIG. 3 illustrates a diagram explaining a layout data base (layout DB);

FIGS. 4A and 4B illustrate diagrams explaining a via alteration rule;

FIG. 5 illustrates a diagram indicating an isolated via before a via alteration;

FIG. 6 illustrates a diagram indicating a via for treating an isolated-via-error (hereinafter referred to as an “isolated-via-error-treatment via”) after the via alteration;

FIG. 7 illustrates a comparative example of the control method;

FIG. 8 illustrates an example of the via alteration;

FIG. 9 illustrates another example of the via alteration;

FIG. 10 illustrates yet another example of the via alteration;

FIG. 11 illustrates still yet another example of the via alteration;

FIG. 12 illustrates still yet another example of the via alteration;

FIG. 13 illustrates still yet another example of the via alteration; and

FIG. 14 illustrates still yet another example of the via alteration.

### DETAILED DESCRIPTION OF EMBODIMENT(S)

Hereinafter, an embodiment will be disclosed with reference to drawings. It should be noted that a structure of the embodiment hereinafter disclosed is just one example and it is needless to say that the present invention is not limited to the structure of the embodiment.

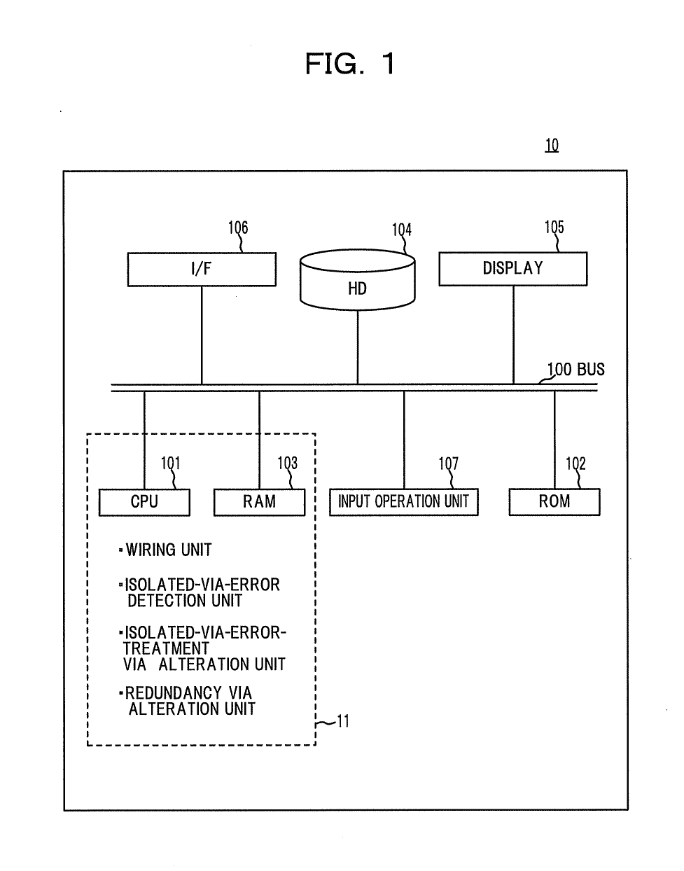

FIG. 1 illustrates a block diagram that indicates a hardware configuration of a semiconductor substrate wiring design support device according to the embodiment.

A semiconductor substrate wiring design support device 10 includes a central processing unit (CPU) 101, a read only memory (ROM) 102, a random access memory (RAM) 103, a storage device 104, a display 105, an interface (I/F) 106, and an input operation unit 107, in FIG. 1. Each of the structural elements disclosed above are electrically connected with each other through a bus 100.

The CPU 101 executes arithmetic processing according to programs to control each of the structural elements. The ROM 102 stores a basic input/output system (BIOS), such as a boot program or the like. The RAM 103 is a so-called main memory used as a memory area that stores data or the programs including instructions of the CPU 101.

The storage device 104 is provided with a storage medium. The storage device 104 writes data to the storage medium and reads the data stored in the storage medium. The storage medium according to the embodiment stores an operating system (OS), control programs, logical connection information of the semiconductor, design rules for the semiconductor, and a layout data base (layout DB).

As the storage device 104, for example, there may be mentioned a solid state drive (SSD), a hard disk drive (HDD), a blu-ray disk (BD) drive, a digital versatile disk (DVD) drive, a compact disk (CD) drive, a memory card device and a flexible disk drive. As the storage medium of the storage device 104, for example, there may be mentioned a non-volatile semiconductor memory (flash memory), a hard disk, a BD, a DVD, a CD, a memory card, and a flexible disk. The storage media as disclosed above, as the examples, may be detachably attached relative to the storage device 104 or fixedly attached inside the storage device 104. Note that the storage media according to the embodiment are computer readable recording media.

The display 105 displays not only a cursor, an icon, and a tool box but also data such as a document, an image, function information, and so on. As the display 108, for example, a cathode ray tube (CRT), a thin film transistor liquid crystal display (TFT-LCD), a plasma display or the like may be used.

The I/F 106 is electrically connected to a network, such as the Internet, through a communication line, so that the I/F 106 is further electrically connected to the other device(s) through the network. The I/F 106 functions as an interface between the network and internal interfaces, and controls a data input/output to/from an external device. As the I/F 109, for example, a modem and a local area network (LAN) adapter or the like may be employed.

The input operation unit 107 is a user interface, such as a keyboard, a mouse or the like, that allows a user's input operations. The keyboard is provided with keys used for inputting a variety of characters, numerals, instructions, and so on. The keyboard is used for data entry. The input operation unit 107 may be an input pad in a touch panel fashion, ten keys or the like. The mouse is used for moving a cursor, for selecting an area, for moving a window, for changing window size, and so on. A track ball, a joy stick or the like provided with the same or similar function to a pointing device may be possible instead thereof.

An arithmetic processing unit 11 that includes the CPU 101 and the RAM 103 not only reads the OS or the control programs from the storage device 104 as necessary to execute but also performs arithmetic processing on information input from the input operation unit 107 and the I/F 106 and on information read from the storage device 104. This arithmetic processing allows the arithmetic processing unit 11 to function as a wiring unit, an isolated-via-error detection unit, a via alteration unit for treating an isolated-via-error (hereinafter, referred to as an “isolated-via-error-treatment via alteration unit”), and a redundancy via alteration unit.

The arithmetic processing unit 11 as the wiring unit performs wiring on (wiring design for) a semiconductor substrate based on the logical connection information. When a wire is wired between a first wire layer and a second wire layer, a single via, which is a singular via, is provided between the first wire layer and the second wire layer to connect electrically.

With respect to a via held by a wire wired on the semiconductor substrate by the wiring unit, the arithmetic processing unit 11, as the isolated-via-error detection unit, determines whether or not a plurality of vias is necessary based upon a via alteration rule, for example, based on a first wire width of a first wire and a second wire width of a second wire, electrically connected by the via. When a determination that the plurality of vias are necessary is made and only a single via is provided, the arithmetic processing unit 11 detects the single via as the isolated-via-error.

The arithmetic processing unit 11, as the isolated-via-error-treatment via alteration unit, alters the single via detected by the isolated via error detection unit, as the isolated-via-error, to an isolated-via-error-treatment via with a plurality of vias.

The arithmetic processing unit 11, as the redundancy via alteration unit, alters the single via of the plurality of vias held by the wire wired on the semiconductor substrate by the wiring unit to a redundancy via with a plurality of vias after the alteration of the detected single isolated-via-error is performed by the isolated-via-error-treatment via alteration unit to the isolated-via-error-treatment via.

The arithmetic processing unit 11, as a design rule check unit, checks the design rule of the semiconductor, with respect to the single via of the vias held by the wire wired on the semiconductor substrate by the wiring unit, after the alteration to the redundancy via made by the redundancy via alteration unit.

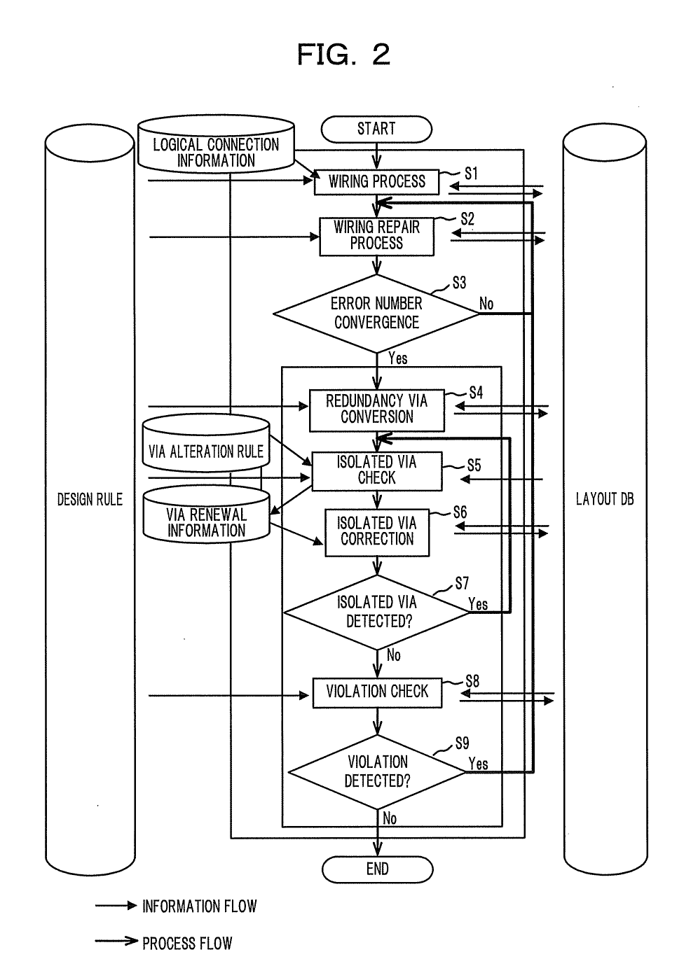

FIG. 2 illustrates a diagram explaining a control method performed by the semiconductor substrate wiring design support device according to the control programs.

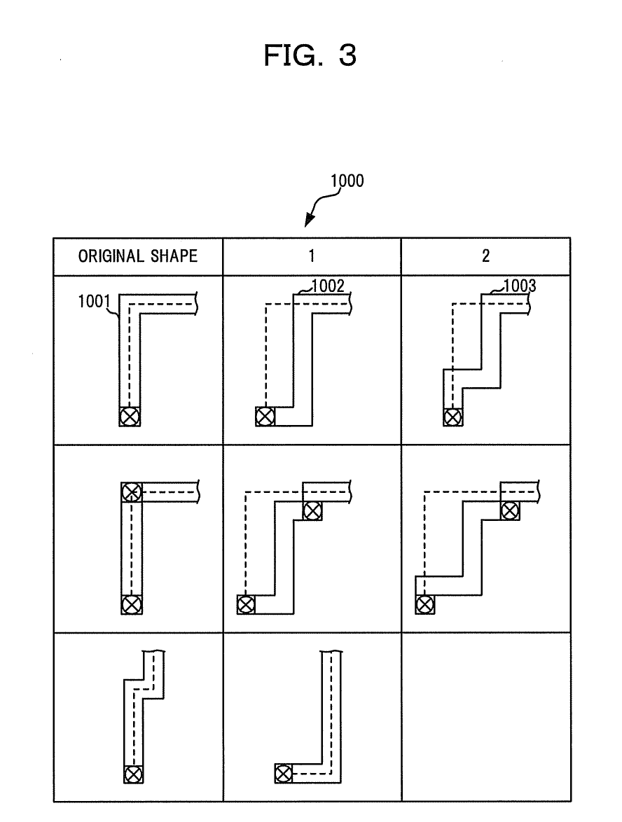

First, the wiring unit performs wiring design processing by reading the logical connection information, design information, and a layout, from the storage device 104. The logical connection information is the information that indicates logical connection relationships in a semiconductor circuit to be designed. The layout is a wiring pattern stored in the layout DB of the storage device 104 as illustrated in FIG. 3. FIG. 3 illustrates an example of a wiring pattern 1000 that includes an original shape 1001, a variant thereof 1002, an another variant thereof 1003, and so on. Note that the original shape 1001 is a basic shape when the wiring is performed according to the logical connection information. That is to say, the wiring unit performs a process that searches for wiring having the same connection relationship as the logical connection information with reference to the layouts in the layout DB (Operation S1).

Next, the wiring unit checks the designed wiring to see whether or not there is a location that violates the design rule of the semiconductor, that is to say, whether or not there is a location on which a short-circuit and/or a lack of clearance between wires is generated. If there is such a violation location, the wiring unit corrects the violation location (Operation S2). After the correction, the wiring unit again checks to see whether or not there is a location that violates the design rule, and the wiring unit repeats the processes of Operation S2 to Operation S3 until no violation location is found (Operation S3).

When there is found no location that violates the design rule, the redundancy via alteration unit alters the single via of the vias held by the wire wired on the semiconductor substrate by the wiring unit, to the redundancy via with the plurality of vias, based on the design rule of the semiconductor (Operation S4).

Then, after alteration to the redundancy via, the isolated-via-error detection unit detects the isolated via, based on a via alteration rule (Operation S5). For example, as a first via alteration rule, with respect to a via held by a wire wired on the semiconductor substrate by the wiring unit, the isolated via detection unit determines whether or not a plurality of vias is necessary, based on a first wire width and a second wire width of the first wire and the second wire, electrically connected by the via.

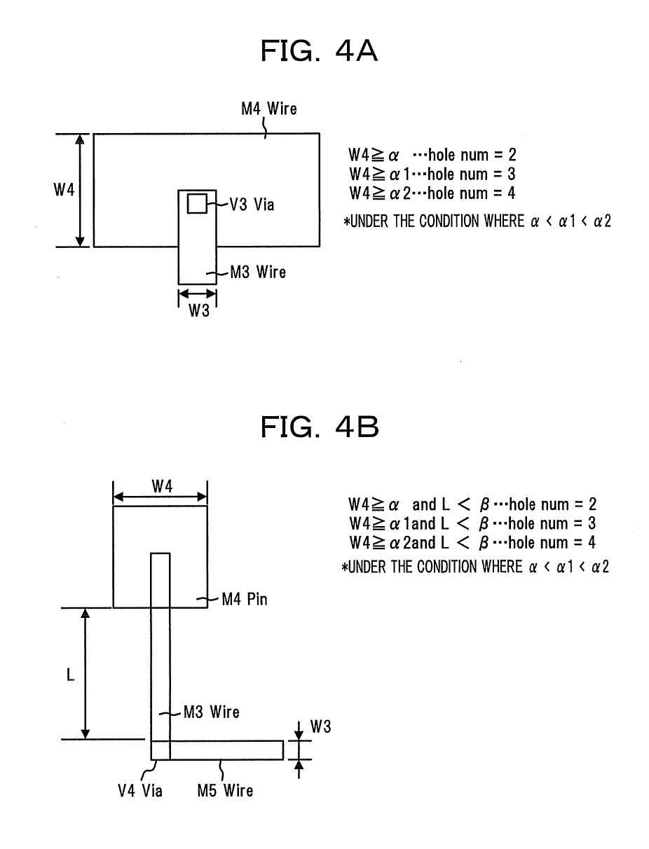

FIG. 4A illustrates a diagram explaining a first via alteration rule. Based on a wire width W4 and a wire width W3 of a first wire M4 and a second wire M3 electrically connected by a via V3 and a value “alpha (α)” obtained by multiplying the wire width W3 by a given coefficient “f”, if W4 is equal to or greater than (≧)α, the via V3 is determined to be the isolated via and it is determined that the number of necessary vias is two (2). Moreover, if W4 is equal to or greater than (≧)α1 under the condition where it is defined as “α<α1<α2”, the number of necessary vias is three (3). In the same manner, if W4 is equal to or greater than (≧) α2 under the same condition, it is determined that the number of necessary vias is four (4).

FIG. 4B illustrates a diagram explaining a second via alteration rule. Even when a via V4 is electrically connected to the second wire M3 and a third wire M5 each having the same wire width W3, the via V3 is determined to be the isolated via under the condition where a distance L from the first wire M4 is less than a given value “beta (β)” and W4 is equal to or greater than (≧) α.

In response to detection of the isolated via, the isolated-via-error-treatment via alteration unit alters the detected isolated via to the isolated-via-error-treatment via with the plurality of vias. In other words, the isolated-via-error-treatment via alteration unit performs correction in which the isolated-via-error-treatment via is added depending on the number of necessary vias (Operation S6).

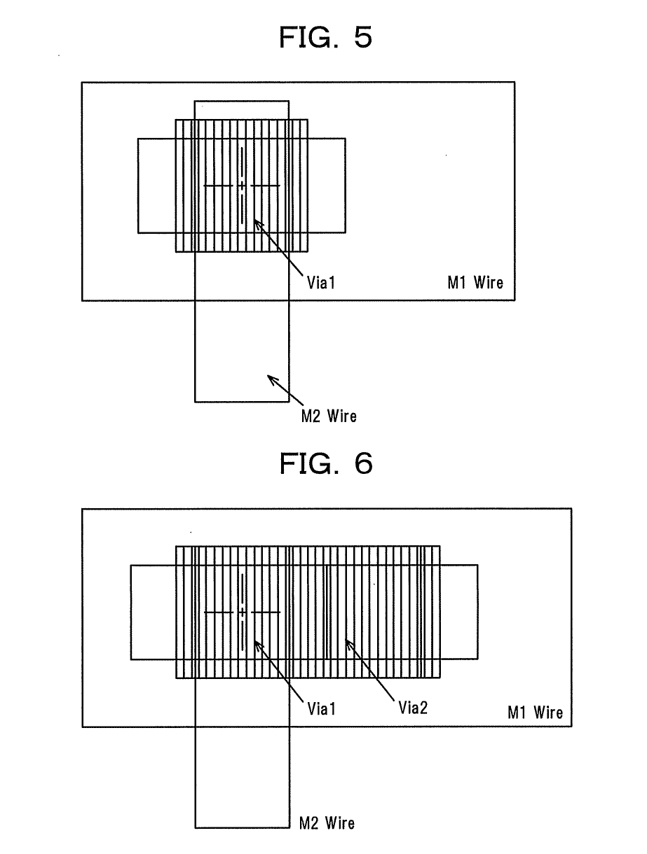

FIG. 5 illustrates a diagram of the isolated via before the alteration. FIG. 6 illustrates a diagram of the isolated-via-error-treatment via after the alteration. In addition, after the correction of the isolated via, the isolated-via-error detection unit performs the detection of the isolated via again (Operation S7). In response to the detection of the isolated via (Operation S7: Yes), the isolated-via-error-treatment via alteration unit returns its process to Operation S6 and alters the detected isolated via to the isolated-via-error-treatment via with the plurality of vias.

When the isolated via is not detected in Operation S7 (Operation S7: No), the design rule check unit checks the designed wiring to see whether or not there is a location that violates the design rule. If there is a violation location, the design rule check unit returns its process to the Operation S2 (through Operations S8 to S9) and the wiring unit corrects the violation location. Then, the design rule check unit terminates its process if no violation location is found, in Operation S9.

As disclosed above, since the semiconductor substrate wiring design support device 10 according to the embodiment is capable of checking the violation location after the alteration of the redundancy via and returning to its wiring repair process (Operation S2) to alter the wiring in response to the violation location, the number of locations capable of being altered to the redundancy via increases, so that a redundancy rate may be improved. The embodiments are not limited to the described first and second via alteration rules, but any combination of these rules and/or other rules may be defined.

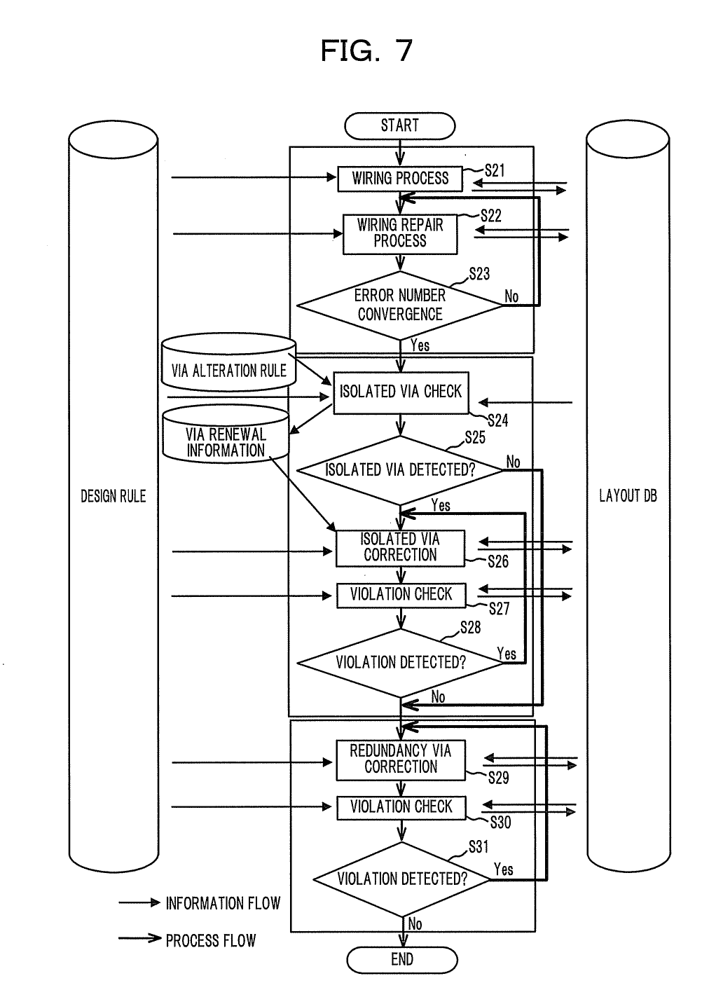

FIG. 7 illustrates a comparative example in which the redundancy via is altered at a last stage subsequent to the determination of the wiring in FIG. 2.

First, the wiring unit performs the wiring processing by reading the logical connection information, the design information, and the layout, from the storage device 104 (Operation S21).

Next, the wiring unit checks the designed wiring to see whether or not there is a location that violates the design rule, that is to say, whether or not there is a location on which a short-circuit and/or a lack of clearance between wires is generated. If there is such a violation location, the wiring unit corrects the violation location (Operation S22). After the correction, the wiring unit again checks to see whether or not there is a location that violates the design rule, and the wiring unit repeats the processes of Operation S22 to S23 until no violation location is found (Operation S23).

As a result of repeating each of the processes, that is, Operations S22 to S23, when there is found no location that violates the design rule of the semiconductor, the isolated-via-error detection unit detects the isolated via based on the via alteration rule (Operation S24).

In response to the detection of the isolated via (Operation S25 Yes), the isolated-via-error-treatment via alteration unit alters the detected isolated via to the isolated-via-error-treatment via with the plurality of vias (Operation S26).

Next, the design rule check unit again checks the designed wiring to see whether or not there is a location that violates the design rule of the semiconductor. If there is a violation location, the design rule check unit returns its process to Operation S26, so that the violation is corrected (through Operations S27 and 28).

Then, the redundancy via alteration unit alters the single via of the vias held by the wire wired on the semiconductor substrate by the wiring unit, to the redundancy via with the plurality of vias (Operation S29).

The wiring unit again checks the designed wiring to see whether or not there is a location that violates the design rule. If there is such a violation location, the wiring unit returns its process to Operation S29 to correct the violation location (Operations S30 and S31). Then, the wiring unit terminates its process if no violation location is found, in Operation S31.

In the comparative example illustrated in FIG. 7, when the determination on the wiring is made in Operations S21 through S23 and subsequently in operations S24-S31 the via is made redundant, the correction thereof is only made within the limit where the design rule is not violated. As a result, the locations capable of being made redundant are restricted.

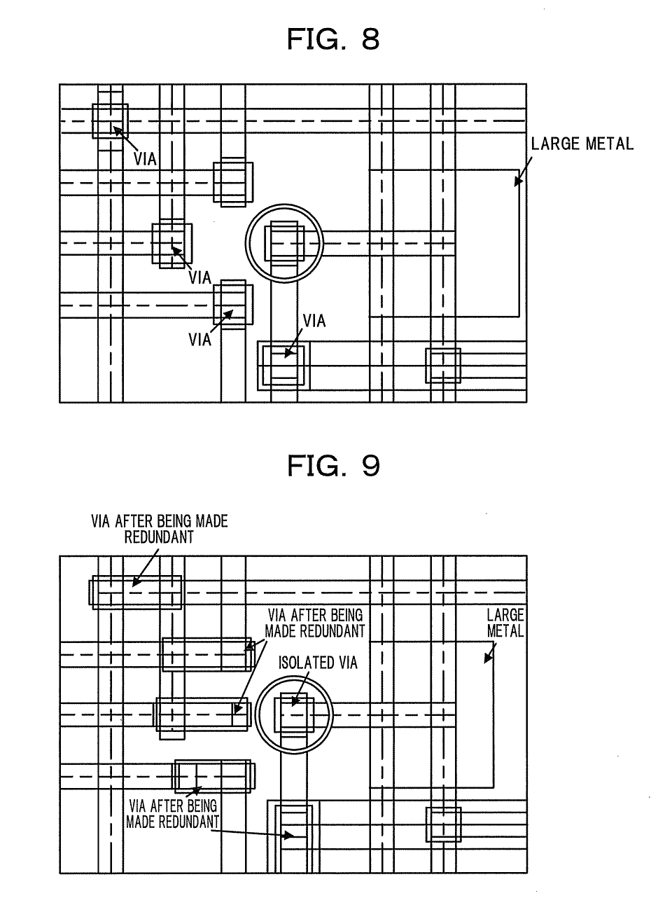

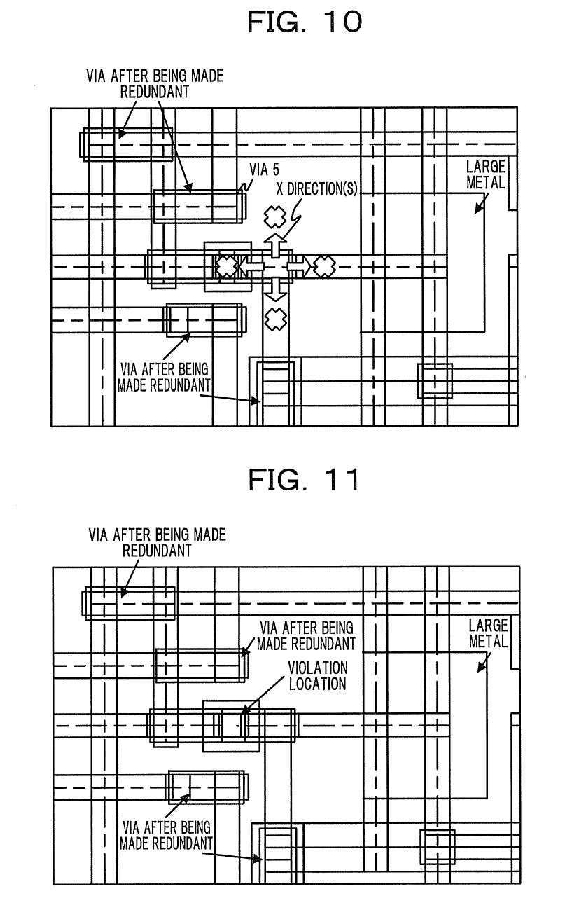

On the other hand, in the example illustrated in FIG. 2, since the wiring is capable of being altered as a result of the redundancy processing if there is a violation location, so that the number of locations capable of being made redundant increases. Consequently, this allows the redundancy rate to be improved. For example, when the redundancy via alteration in Operation S4 is made in a case where there is no violation location that violates the design rule in Operation S3 and the state illustrated in FIG. 8 is brought about, a via indicated with a circle illustrated in FIG. 9 remains without being made redundant. The reason of the failure in redundancy processing is that providing a via, made redundant in any of the directions illustrated in FIG. 10, results in violation of the design rule. Note that when the via indicated with the circle is made redundant in any of the directions indicated with “X” in FIG. 10, since the via is in proximity to a via 5, which is provided in the orthogonal direction, on the same plane, this also results in the violation of the design rule. Moreover, in the example in FIG. 9, since the via indicated with the circle is electrically connected with a large metal, this via is detected as the isolated via in subsequent Operation S5.

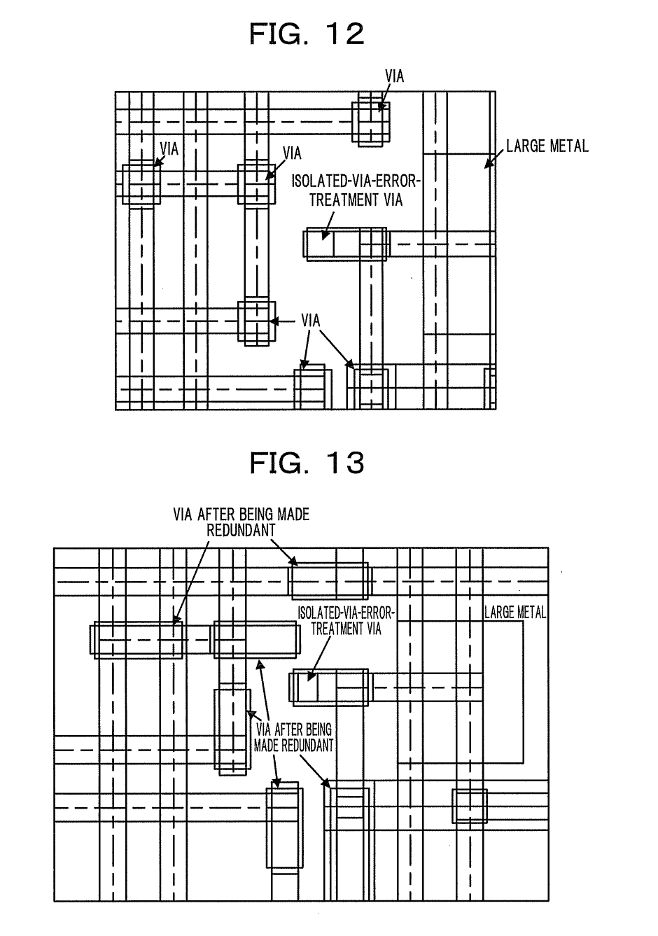

Due to this, the isolated-via-error-treatment via alteration unit corrects the isolated via indicated with the circle. For example, the isolated-via-error-treatment via is provided in the manner as illustrated in FIG. 11. Since this case falls under the design rule violation, the violation is detected in Operations S8 and S9. As a result thereof, the isolated-via-error-treatment via alteration unit returns its process to Operation S2 to correct the wiring as illustrated in FIG. 12.

Then, the via is made redundant again (Operation S4), so that all the vias are capable of being made redundant without errors, as illustrated in FIG. 13.

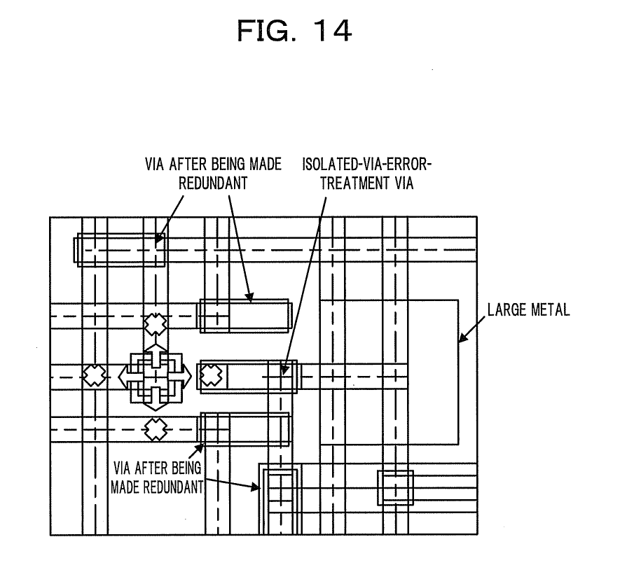

On the other hand, in the comparative example in FIG. 7, when the redundancy processing indicated in Operation S27 is performed under the state illustrated in FIG. 8, a via indicated with a square as illustrated in FIG. 14 remains without being made redundant. In the comparative example in FIG. 7, since it is unable to alter the wiring by returning to Operation S22 to alter the wiring, further redundancy processing is unavailable. As disclosed hereinabove, according to the present embodiment, the processing of the via redundancy rate may be improved.

It is needless to say that the present invention is not limited to the example disclosed hereinabove. It is also needless to say that various modifications and changes may be made without departing from the scope and the spirit of the present invention.

According to an aspect of the embodiments of the invention, any combinations of one or more of the described features, functions, operations, and/or benefits can be provided. A combination can be one or a plurality. The embodiments can be implemented as an apparatus (a machine), for example, the semiconductor substrate wiring design support device 10, that includes computing hardware (i.e., computing apparatus), such as (in a non-limiting example) any computer with a computer processor that can store, retrieve, process and/or output data and/or communicate (network) with other computers. According to an aspect of an embodiment, the described features, functions, operations, and/or benefits can be implemented by and/or use computing hardware and/or software. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations.

A program/software implementing the embodiments may be recorded on computer-readable recording media. The program/software implementing the embodiments may also be included/encoded as a data signal and transmitted over transmission communication media. A data signal moves on transmission communication media, such as wired network or wireless network, for example, by being incorporated in a carrier wave. The data signal may also be transferred by a so-called baseband signal. A carrier wave can be transmitted in an electrical, magnetic or electromagnetic form, or an optical, acoustic or any other form.

All examples and conditional language recited herein are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A semiconductor substrate wiring design support device for supporting a wiring design of a semiconductor substrate, the semiconductor substrate wiring design support device comprising:
a memory unit that stores logical connection information of the semiconductor substrate;
a wiring unit that performs wiring on a semiconductor substrate based on the logical connection information and provides a single via between a first wire layer and a second wire layer when the wiring is a wire between the first wire layer and the second wire layer;
an isolated-via-error detection unit that detects the single via as an isolated-via-error when only the single via is provided in a case where a plurality of vias are needed according to a via alteration rule;
an isolated-via-error-treatment via alteration unit that alters the single via detected as the isolated-via-error by the isolated-via-error detection unit to an isolated-via-error-treatment via with a plurality of vias; and
a redundancy via alteration unit that alters a single via of vias held by the wire wired on the semiconductor board by the wiring unit to a redundancy via with a plurality of vias after the alteration to the isolated-via-error-treatment via made by the isolated-via-error-treatment via alteration unit.

2. The semiconductor substrate wiring design support device according to claim 1, further comprising:
a design rule check unit that checks a single via of the vias based on a design rule after the alteration to the redundancy via made by the redundancy via alteration unit.

3. The semiconductor substrate wiring design support device according to claim 2, wherein when the design rule check unit detects a single via with the isolated-via-error out of the design rule, the isolated-via-error-treatment via alteration unit further alters the single via with the isolated-via-error to the isolated-via-error-treatment via.

4. The semiconductor substrate wiring design support device according to claim 1, wherein when the isolated-via-error-treatment via alteration unit alters the single via detected as the isolated-via-error to the isolated-via-error-treatment via, the alteration to the isolated-via-error-treatment via is made regardless of a design rule.

5. The semiconductor substrate wiring design support device according to claim 1, wherein when the redundancy via alteration unit alters the single via of the vias to the redundancy via, the alteration to the redundancy via is made based on the design rule.

6. A method of controlling a semiconductor substrate wiring design support device that includes a memory unit storing logical connection information, the method comprising:
using a computer processor designing wiring for a semiconductor substrate based on the logical connection information;
providing a single via between a first wire layer and a second wire layer when the wiring is a wire between the first wire layer and the second wire layer;
detecting the single via as an isolated-via-error when only the single via is provided in a case where a plurality of vias are needed according to a via alteration rule;
altering the single via detected as the isolated-via-error to an isolated-via-error-treatment via with a plurality of vias; and
altering a single via of vias held by the wire wired on the semiconductor substrate, to a redundancy via with a plurality of vias after the alteration to the isolated-via-error-treatment via.

7. The method according to claim 6, further comprising:
checking a single via of the vias based on a design rule after the alteration to the redundancy via.

8. The method according to claim 7, further comprising:
altering a single via with the isolated-via-error to the isolated-via-error-treatment via when the single via with the isolated-via-error out of the design rule is detected in the operation of checking the design rule.

9. The method according to claim 6 wherein when the single via detected as the isolated-via-error is altered to the isolated-via-error-treatment via, the alteration to the isolated-via-error-treatment via is made regardless of a design rule.

10. The method according to claim 6 wherein when the single via of the vias is altered to the redundancy via, the alteration to the redundancy via is made based on a design rule.

11. A computer readable recording medium that stores a program for controlling a semiconductor substrate wiring design support device that includes a memory unit storing logical connection information and an arithmetic processing unit, the computer readable recording medium causing the arithmetic processing unit to execute operations comprising:
designing wiring for a semiconductor substrate based on the logical connection information;
providing a single via between a first wire layer and a second wire layer when the wiring is a wire between the first wire layer and the second wire layer;
detecting the single via as an isolated-via-error when only the single via is provided in a case where a plurality of vias are needed according to a via alteration rule; altering a single via, detected as the isolated-via-error, to an isolated-via-error-treatment via with a plurality of vias; and
altering a single via of vias held by the wire wired on the semiconductor substrate, to a redundancy via with a plurality of vias after the alteration to the isolated-via-error-treatment via.

12. The computer readable recording medium according to claim 11, further comprising:
checking a single via of the vias based on a design rule after the alteration to the redundancy via.

13. The computer readable recording medium according to claim 12, further comprising:
altering a single via with the isolated-via-error, to the isolated-via-error-treatment via when the single via with the isolated-via-error out of the design rule is detected in the operation of checking the design rule.

14. The computer readable recording medium according to claim 11 wherein when the single via detected as the isolated-via-error is altered to the isolated-via-error-treatment via, the alteration to the isolated-via-error-treatment via is made regardless of a design rule.

15. The computer readable recording medium according to claim 11 wherein when the single via of the vias is altered to the redundancy via, the alteration to the redundancy via is made based on a design rule.

16. The device according to claim 1, wherein the via alteration rule is when a plurality of vias corresponding to a first wire width are needed based on the first wire width of a first wire and a second wire width of a second wire, or a distance of the second wire from the first wire, or any combination thereof.

17. The method according to claim 6, wherein the via alteration rule is when a plurality of vias corresponding to a first wire width are needed based on the first wire width of a first wire and a second wire width of a second wire, or a distance of the second wire from the first wire, or any combination thereof.

18. The computer readable recording medium according to claim 11, wherein the via alteration rule is when a plurality of vias corresponding to a first wire width are needed based on the first wire width of a first wire and a second wire width of a second wire, or a distance of the second wire from the first wire, or any combination thereof.
